(19) United States
(12) Patent Application Publication
(10) Pub. No.: US 2024/0227061 A1
(43) Pub. Date: Jul. 11, 2024

(54) WELDING AND POST-WELDING TREATMENT OF TITANIUM ALLOY MADE VIA ULTRASONIC ADDITIVE MANUFACTURING

(71) Applicants: Ohio State Innovation Foundation, Columbus, OH (US); University of Tennessee Research Foundation, Knoxville, TN (US)

(72) Inventors: Marcelo Dapino, Columbus, OH (US); Leon Headings, Columbus, OH (US); Ningxiner Zhao, Columbus, OH (US); Suresh Babu, Knoxville, TN (US); Michael Pagan, Atlanta, GA (US); Steven Zinkle, Knoxville, TN (US)

(21) Appl. No.: 18/374,434

(22) Filed: Sep. 28, 2023

Related U.S. Application Data
(60) Provisional application No. 63/410,773, filed on Sep. 28, 2022.

(51) Int. Cl. B23K 20/10; B23K 103/14; B33Y 10/00; B33Y 40/20; C22F 1/00; C22F 1/18

(52) U.S. Cl. CPC B23K 20/10; B33Y 10/00; B33Y 40/20; C22F 1/002; C22F 1/183; B23K 2103/14

(57) ABSTRACT

A method of welding a first layer of Ti alloy to a second layer of Ti alloy. The method includes disposing a metallic interlayer onto a first layer of Ti alloy, disposing the second layer of Ti alloy onto the metallic interlayer such that the metallic interlayer is disposed between the first layer of Ti alloy and the second layer of Ti alloy, and applying a horn of an ultrasonic device to the second layer of Ti alloy to weld the first layer of Ti alloy to the second layer of Ti alloy to form a welded material.

### CROSS-REFERENCE TO RELATED APPLICATIONS

This application claims the benefit of U.S. Provisional Patent Application No. 63/410,773, filed on Sep. 28, 2022, the entire contents of which are incorporated herein by reference.

### STATEMENT OF GOVERNMENT SUPPORT

This invention was made with government support under FA864920P0998 awarded by the Air Force Research Laboratory. The government has certain rights in the invention.

### BACKGROUND

This disclosure relates to ultrasonic consolidation or ultrasonic additive manufacturing. More specifically, this disclosure relates to ultrasonic additive manufacturing of titanium and titanium alloys.

### SUMMARY

One embodiment relates to a method of welding a first layer of Ti alloy to a second layer of Ti alloy. The method includes disposing a metallic interlayer onto a first layer of Ti alloy, disposing the second layer of Ti alloy onto the metallic interlayer such that the metallic interlayer is disposed between the first layer of Ti alloy and the second layer of Ti alloy, and applying a horn of an ultrasonic device to the second layer of Ti alloy to weld the first layer of Ti alloy to the second layer of Ti alloy to form a welded material.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRA WINGS

The device is explained in even greater detail in the following drawings. The drawings are merely exemplary and certain features may be used singularly or in combination with other features. The drawings are not necessarily drawn to scale.

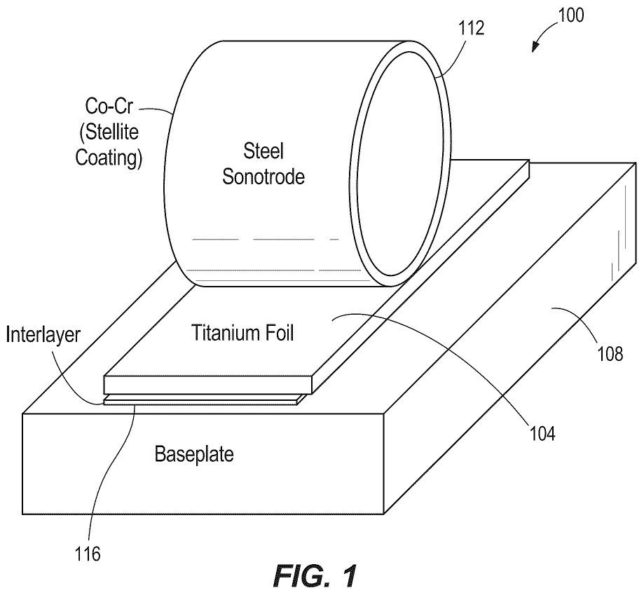

FIG. 1 is a schematic representation of a ultrasonic additive manufacturing process, according to some implementations.

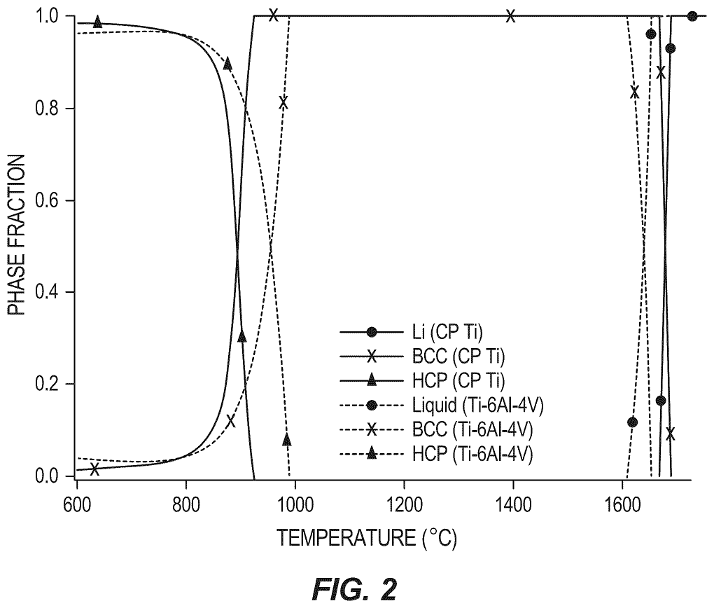

FIG. 2 is a graph showing simulated phase fractions of commercially pure (CP) Titanium (Ti) and Ti-6Al-4V versus temperature, according to some implementations.

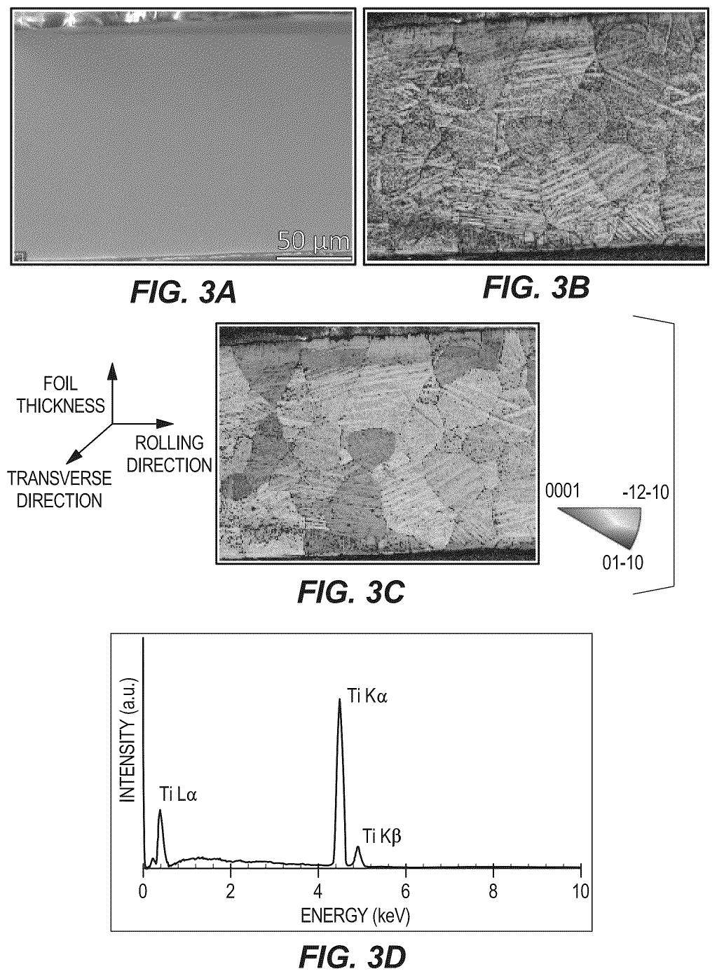

FIG. 3A is a scanning electron microscope image of a CP Ti foil, FIG. 3B is a band contrast image of the as-received CP Ti foil, FIG. 3C is an inverse pole figure (IPF) of an α phase of the as-received CP Ti foil, and FIG. 3D is a graph showing an energy dispersive spectroscopy (EDS) spectrum of the as received CP Ti foil, according to some implementations.

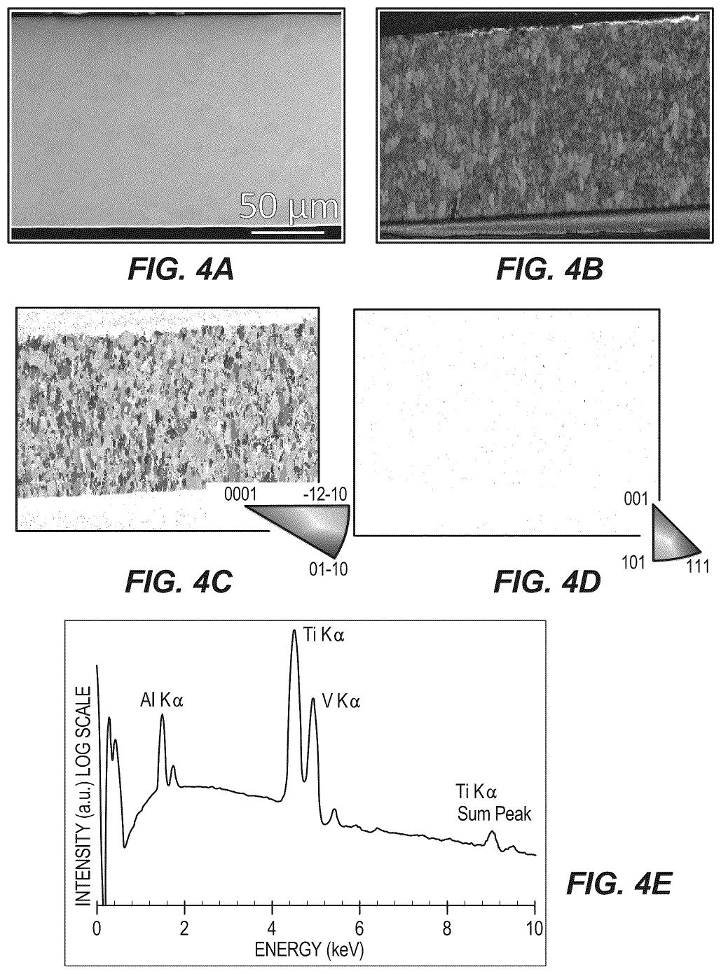

FIG. 4A is a scanning electron microscope image of a Ti-6Al-4V foil, FIG. 4B is a band contrast image of the as-received Ti-6Al-4V foil, FIG. 4C is an inverse pole figure (IPF) of an α phase of the as-received CP Ti foil, FIG. 4D is an inverse pole figure (IPF) of a β phase of the as-received Ti-6Al-4V foil, and FIG. 4E is a graph showing an energy dispersive spectroscopy (EDS) spectrum of the as received Ti-6Al-4V foil, according to some implementations.

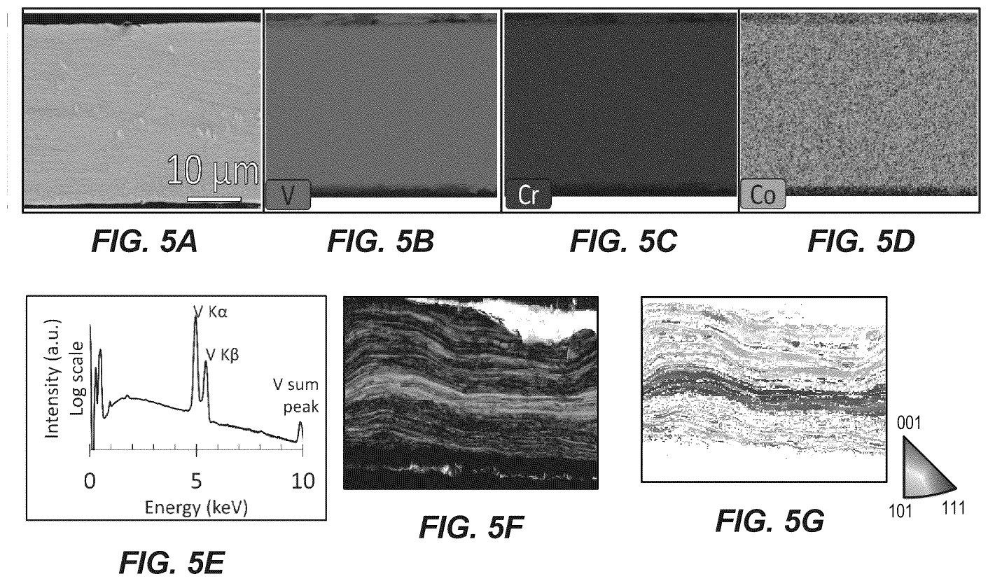

FIG. 5A is a backscattered electron image of a vanadium interlayer foil, FIG. 5B is an energy dispersive spectroscopy (EDS) map of vanadium, FIG. 5C is an energy dispersive spectroscopy (EDS) map of chromium, FIG. 5D is an energy dispersive spectroscopy (EDS) map of cobalt, FIG. 5E is a graph showing an energy dispersive spectroscopy (EDS) spectrum of the vanadium interlayer foil, FIG. 5F is an electron backscatter diffraction (EBSD) analysis image showing band contrast, and FIG. 5G is an electron backscatter diffraction (EBSD) analysis image showing BCC-IPF, according to some implementations.

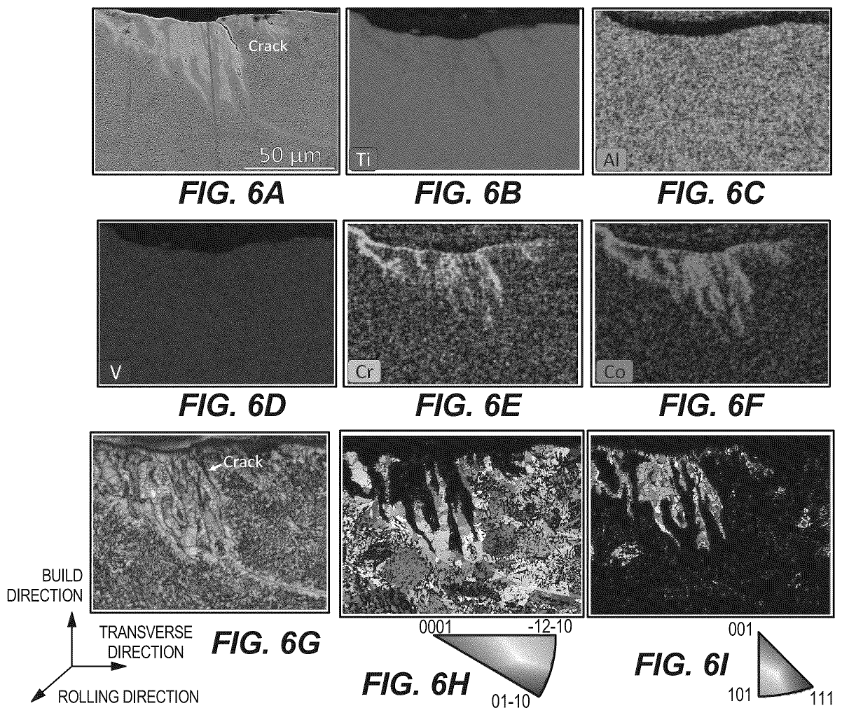

FIGS. 6A-6I show a CP Ti foil bonded using UAM where FIG. 6A is a SEM-BSE of the bonded foil, FIG. 6B is a quantified EDS map of titanium, FIG. 6C is a quantified EDS map of aluminum, FIG. 6D is a quantified EDS map of vanadium, FIG. 6E is a quantified EDS map of chromium, FIG. 6F is a quantified EDS map of cobalt, FIG. 6G is an EBSD analysis image showing band contrast, FIG. 6H is an IPF of an α phase, and FIG. 6I is an IPF of a β phase, according to some implementations.

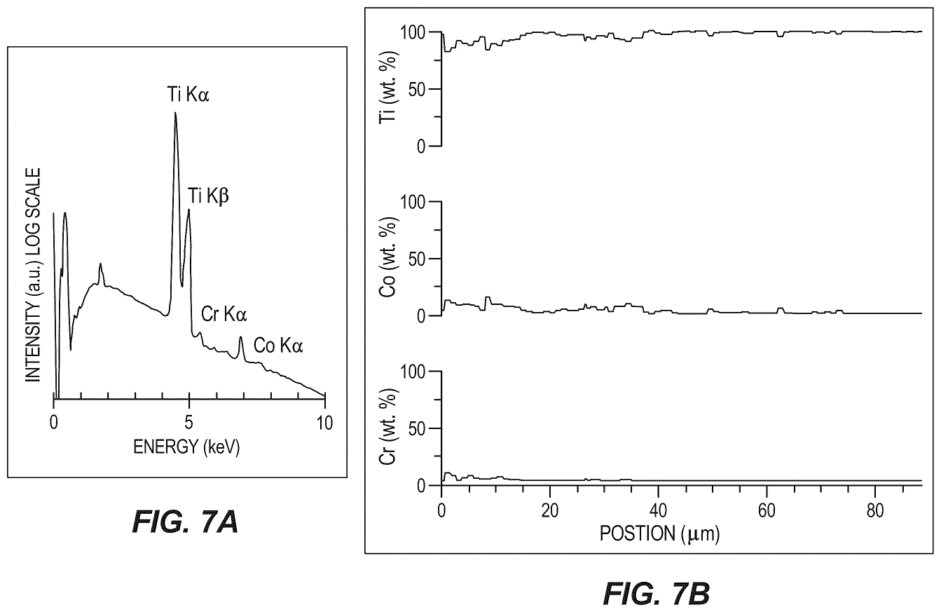

FIG. 7A is a graph of the EDS spectrum of the bonded CP Ti foil, and FIG. 7B is an EDS line scan of titanium, cobalt, and chromium, according to some implementations.

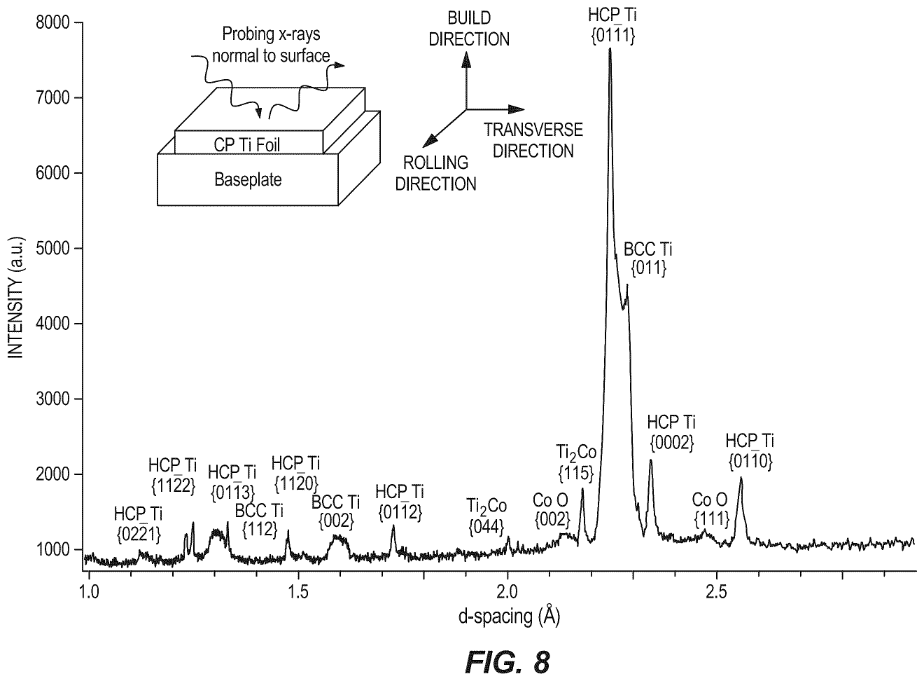

FIG. 8 is a graph of x-ray diffraction (XRD) normal to a top surface of the bonded CP Ti foil, according to some implementations.

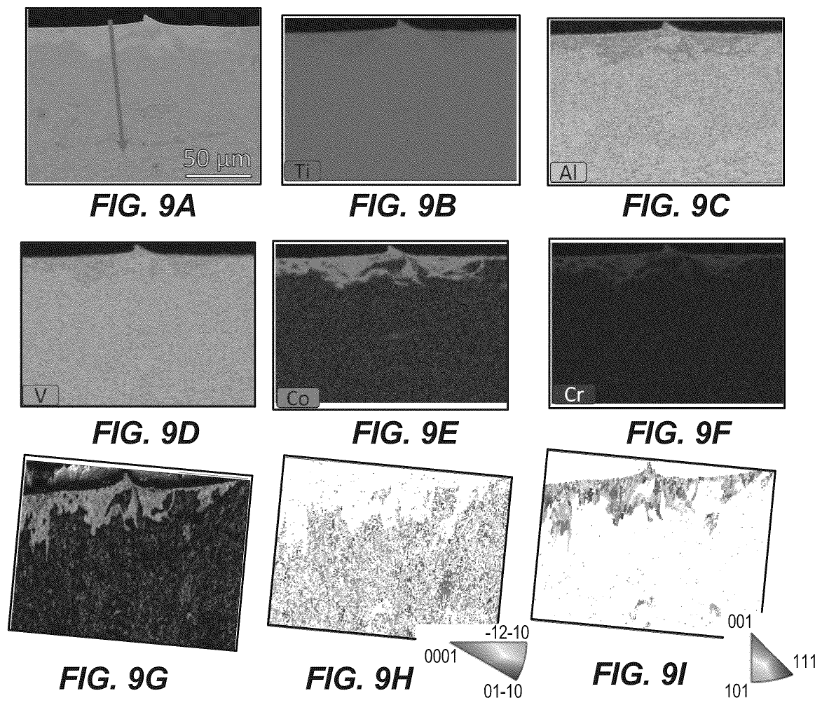

FIGS. 9A-9H show a Ti-6Al-4V foil bonded using UAM where FIG. 9A is a SEM-BSE of the bonded foil, FIG. 9B is a quantified EDS map of titanium, FIG. 9C is a quantified EDS map of aluminum, FIG. 9D is a quantified EDS map of vanadium, FIG. 9E is a quantified EDS map of cobalt, FIG. 9F is a quantified EDS map of chromium, FIG. 9G is an EBSD analysis image showing band contrast, FIG. 9H is an IPF of an α phase, and FIG. 9I is an IPF of a β phase, according to some implementations.

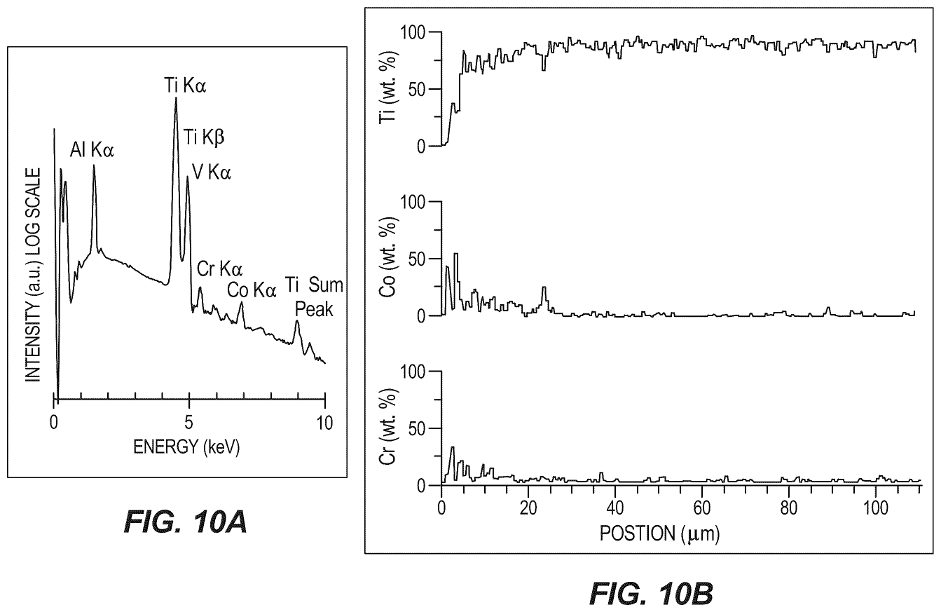

FIG. 10A is a graph of the EDS spectrum of the bonded Ti-6Al-4V foil, and FIG. 10B is an EDS line scan of titanium, cobalt, and chromium, according to some implementations.

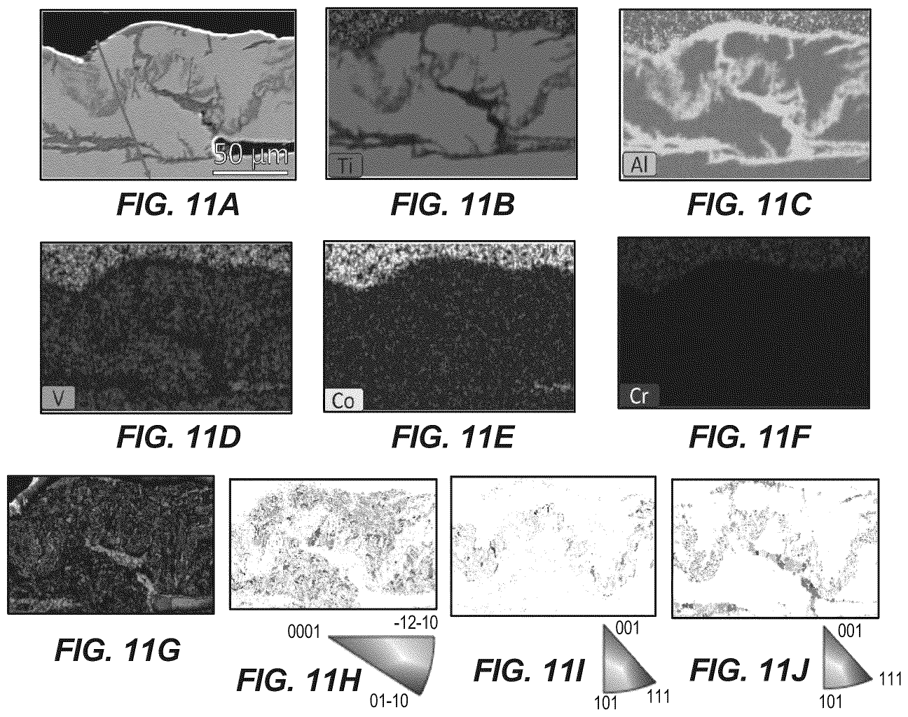

FIGS. 11A-11J show a Ti-6Al-4V foil bonded using UAM and an aluminum interlayer where FIG. 11A is a SEM-BSE of the bonded foil, FIG. 11B is a quantified EDS map of titanium, FIG. 11C is a quantified EDS map of aluminum, FIG. 11D is a quantified EDS map of vanadium, FIG. 11E is a quantified EDS map of cobalt, FIG. 11F is a quantified EDS map of chromium, FIG. 11G is an EBSD analysis image showing band contrast, FIG. 11H is an IPF of a titanium α phase, FIG. 11I is an IPF of a titanium β phase, and FIG. 11J is an IPF of an aluminum FCC phase, according to some implementations.

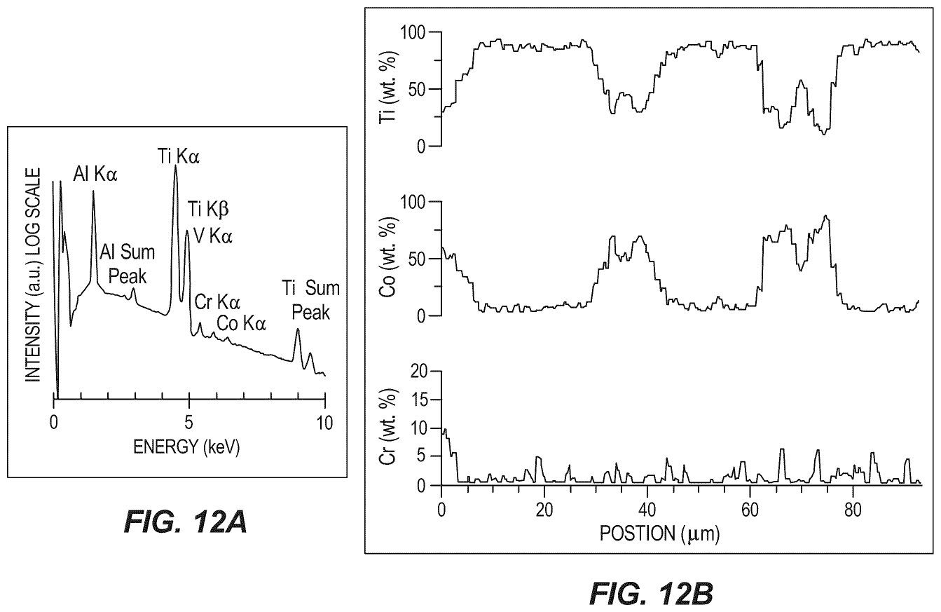

FIG. 12A is a graph of the EDS spectrum of the bonded Ti-6Al-4V foil using the aluminum interlayer, and FIG. 12B is an EDS line scan of titanium, cobalt, and chromium, according to some implementations.

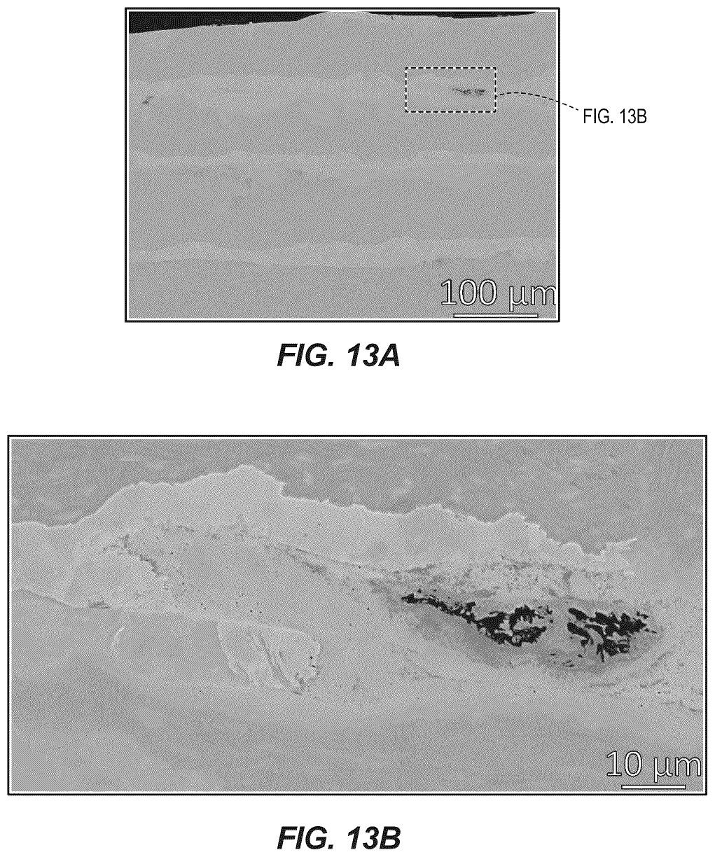

FIG. 13A is a BSE image of the Ti-6Al-4V foil bonded using vanadium interlayers, and FIG. 13B is a detail view of the dashed box region of FIG. 13A, according to some implementations.

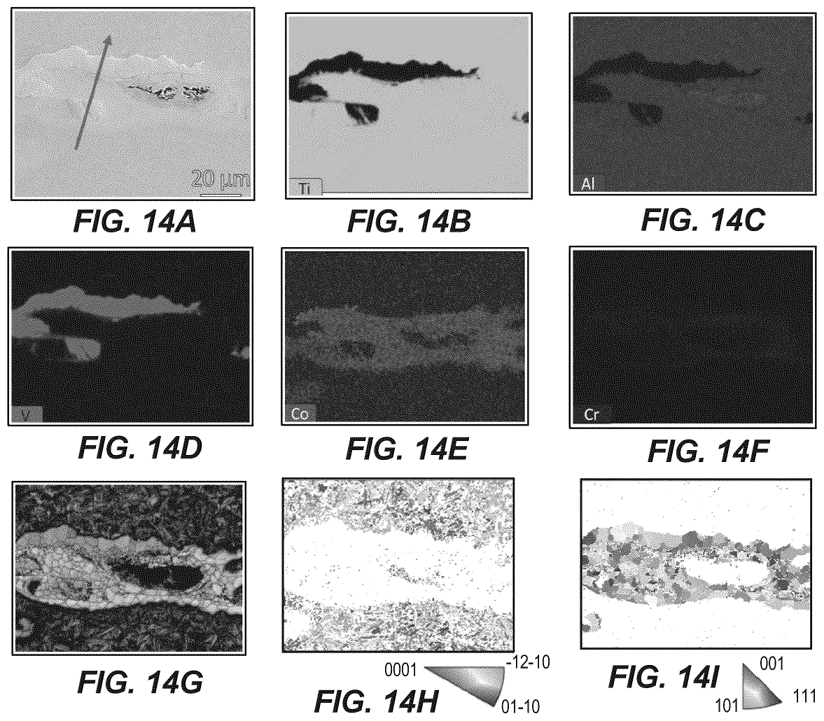

FIGS. 14A-14I show the bonded Ti-6Al-4V foil of FIG. 13A, where FIG. 14A is a SEM-BSE of the bonded foil, FIG. 14B is a quantified EDS map of titanium, FIG. 14C is a quantified EDS map of aluminum, FIG. 14D is a quantified EDS map of vanadium, FIG. 14E is a quantified EDS map of cobalt, FIG. 14F is a quantified EDS map of chromium, FIG. 14G is an EBSD analysis image showing band contrast, FIG. 14H is an IPF of an α phase, and FIG. 14I is an IPF of a β phase, according to some implementations.

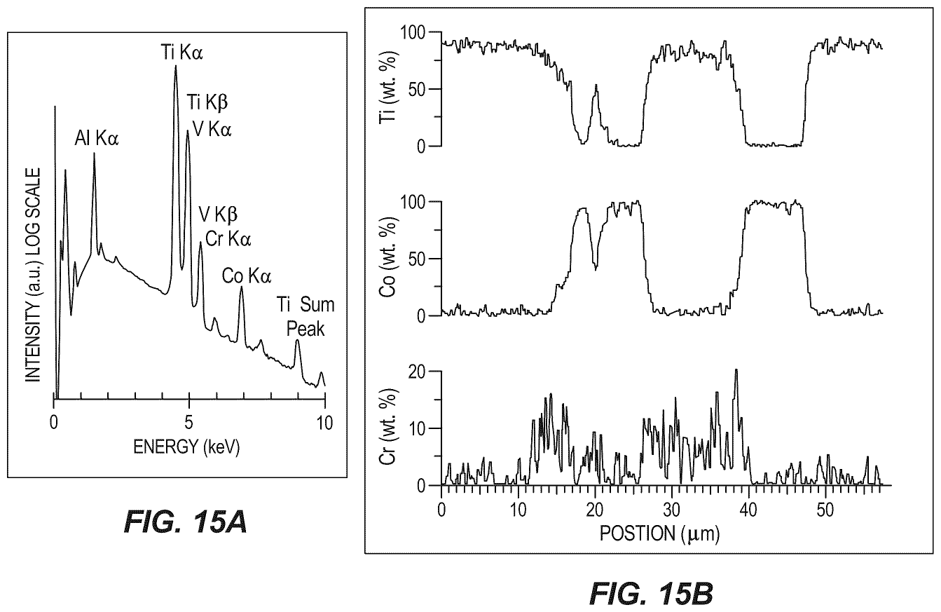

FIG. 15A is a graph of the EDS spectrum of the bonded Ti-6Al-4V foil of FIG. 13A, and FIG. 15B is an EDS line scan of titanium, cobalt, and chromium, according to some implementations.

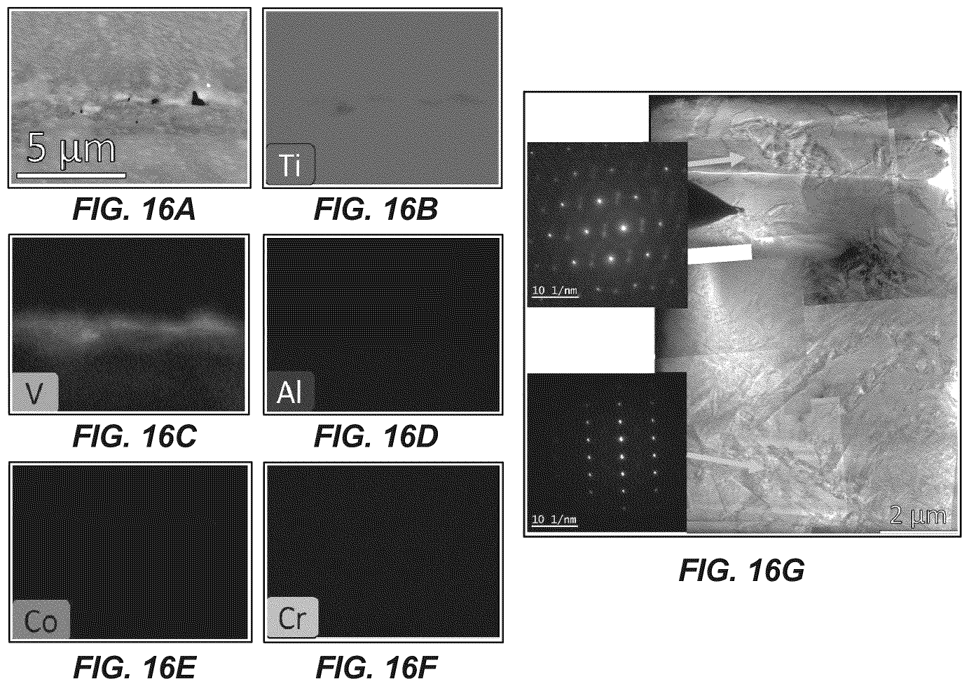

FIGS. 16A-16G show the bonded CP Ti foil including a sputtered vanadium interlayer, where FIG. 16A is a SEM-BSE of the bonded foil, FIG. 16B is a quantified EDS map of titanium,

FIG. 16C is a quantified EDS map of vanadium, FIG. 16D is a quantified EDS map of aluminum, FIG. 16E is a quantified EDS map of cobalt, FIG. 16F is a quantified EDS map of chromium, and FIG. 16G is a transmission electron microscopy (TEM) bright field (BF) image along with convergent beam electron diffraction (CBED), according to some implementations.

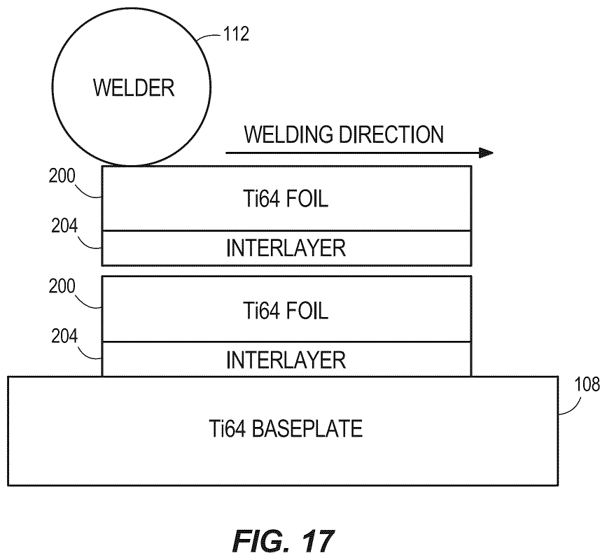

FIG. 17 is a schematic of a multi-level weldment of Ti64 foils produced using UAM on a Ti64 baseplate and vanadium interlayers, according to some implementations.

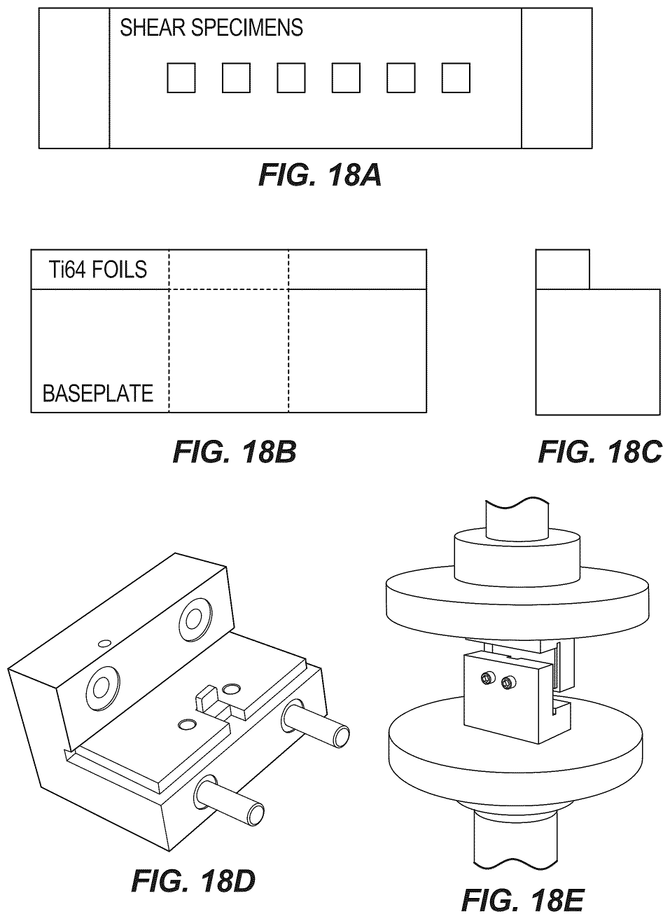

FIGS. 18A-18E shows a shear test fixture, according to some implementations. FIG. 18A is a top view of a shear test fixture, FIG. 18B is section view of the shear test fixture, FIG. 18C is side view of a shear test specimen, FIG. 18D is a perspective view of half of the shear test fixture with the shear test specimen of FIG. 18C loaded therein, and FIG. 18E is a perspective view of the shear test fixture loaded with the shear test sample, according to some implementations.

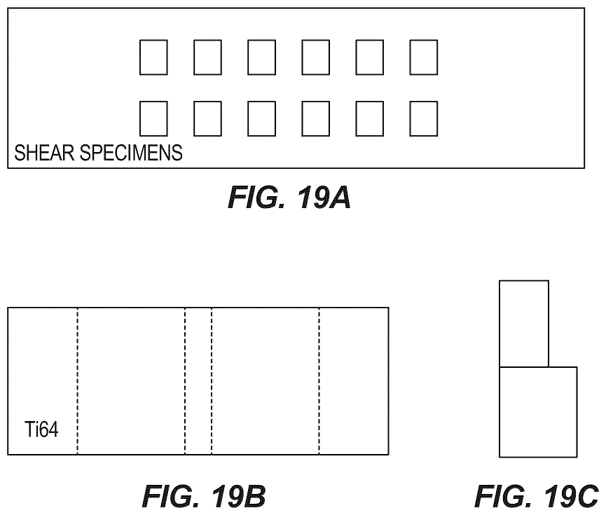

FIGS. 19A-19C shows another shear test fixture, according to some implementations. FIG. 19A is a top view of the shear test fixture, FIG. 19B is a section view of the shear test fixture of FIG. 19A, and FIG. 19C is a shear test specimen sized for use with the shear test fixture of FIG. 19A, according to some implementations.

### DETAILED DESCRIPTION

Following below are more detailed descriptions of concepts related to, and implementations of, methods, apparatuses, and systems for bonding layers of titanium alloys using ultrasonic consolidation or ultrasonic additive manufacturing (UAM). Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the figures generally, the various embodiments disclosed herein relate to systems, apparatuses, and methods for bonding titanium alloys and in particular Ti-6Al-4V using UAM.

Ti-6Al-4V is a titanium alloy with a high specific strength and excellent corrosion resistance which is utilized in a wide range of applications such as aerospace and biomechanical industries. However, the welding of Ti-6Al-4V has proven to be challenging due to its oxygen embrittlement at high temperature and unwanted distortions after welding caused by its low thermal conductivity. The devices, systems, and methods disclosed herein provide for a process to produce high strength joints and 3D-printed Ti-6Al-4V parts using an ultrasonic additive manufacturing (UAM) system in combination with a post-process heat treatment.

UAM is a technology for solid-state welding of foil layers to build up a part. The devices, systems, and methods disclosed herein provide for welding that is achieved well below the melting temperature of the material. However, high strength materials such as Ti-6Al-4V are very difficult to weld due to reasons including the high power required, fatigue caused by the ultrasonic vibrations, and the potential for welding the foil to the sonotrode. The devices, systems, and methods disclosed herein provide for a process to achieve high strength welds with UAM by introducing a vanadium layer between Ti-6Al-4V layers and applying a post-weld heat treatment.

Joining of 0.006 inch (0.15 mm) thick annealed Ti-6Al-4V foil to 0.13 inch (3.30 mm) thick Ti-6Al-4V baseplate is achieved at room temperature via ultrasonic additive manufacturing, avoiding possible oxides caused by high temperature that may prevent bonding. As a β-phase stabilizer, vanadium is introduced in the welding process to facilitate transformation of Ti-6Al-4V from α to β phase and thus improve bonding. A vanadium foil with a thickness of 0.001 inch (0.025 mm) is applied between the baseplate and the Ti-6Al-4V foil to be welded, then the welder is run over the top of the Ti-6Al-4V foil, welding both vanadium and Ti-6Al-4V foil layers together on the baseplate. Introduction of the vanadium layer enables moderate as-welded joint strength via UAM. Next, a post-welding heat treatment is applied to the UAM-welded material which includes three steps: solution treatment at 1065° C. for 1 hour, water quenching, and aging at 605° C. for 5 hours. The post-welding heat treatment hardens the welded material and improves the weld strength. Other heat treatment schedules may be applicable and result in optimized mechanical properties.

Implementations discussed herein provide for phase transformations of hexagonal closed packed materials during the high strain rate (˜105 s−1) plastic deformation ultrasonic additive manufacturing (UAM) process. During testing, the phase transformations were captured by x-ray diffraction, electron backscatter diffraction, and convergent beam electron microscopy, and were rationalized due to the strain induced phase transformation created by UAM and the introduction of elements, observed by energy dispersive x-ray spectroscopy, that can stabilize a body centered cubic structure. The elements were introduced through non-equilibrium point defect vacancy concentrations, which accelerate interdiffusion of elements. The physics described here can also be used to design interlayers and surface modifications, which have been experimentally shown to improve the bonding of difficult to weld materials.

A unique microstructure is developed when bonding titanium using ultrasonic additive manufacturing (UAM). UAM can be used to create a variety of complex three-dimensional components. As shown in FIG. 1, a UAM bonding process 100 includes bonding foils 104 to a base substrate 108, then bonding subsequent foils on top which creates a three-dimensional component. Bonding occurs as a rolling cylindrical horn, known as a sonotrode 112, imparts a downward force on the foil 104, while scrubbing in the lateral direction and rolling in the transverse direction. The UAM sonotrode 112 creates high strain rate (10⁵ s⁻¹) plastic deformation on the material to collapse surface asperities and disperse surface oxides. Once surface imperfections are removed, the materials of the foil 104 can bond at temperatures well below their respective melting temperatures.

In addition to creating atomically clean surfaces, significant plastic deformation occurs during bonding. External temperature is not applied during UAM bonding, but elevated temperatures associated with the UAM deformation process have been recorded (e.g., 150-200° C. for soft Centered Cubic Structure (FCC) metals, and higher temperatures with more difficult to weld materials). The measured thermal cycles are typically less than 0.5 seconds, which includes the ramp up and down temperature. Grain refinement is often observed at UAM bonded interfaces. This is associated with a dynamic recrystallized grain structure due to the high strain rate deformation process. A refined grain structure is typically observed within 10-15 μm of the interface, while the remaining bulk material remains unaffected.

Many previous UAM studies have focused on low strength FCC materials, such as aluminum, copper, and nickel, due to limitations of UAM bonding. The recent introduction of higher power UAM machines combined with the methods of this disclosure can be used to bond more difficult to weld metals. This disclosure demonstrates UAM self-bonding hexagonal close packed crystal (HCP) titanium. Successful solid state UAM bonding of titanium has a wide range of industrial applications due to its high strength, low density, and excellent corrosion properties. Furthermore, understanding bonding through the severe plastic deformation of HCP materials could unleash a wide range of potential applications.

Testing of methods discussed herein were conducted under the following conditions.

Foils (e.g., ˜150 μm thick) of grade 2, commercially pure (CP), titanium foils and grade 5 titanium, Ti-6Al-4V, foils were welded to a Ti-6Al-4V baseplate. These foils were welded directly to the baseplate, and to improve UAM bonding, Ti-6Al-4V foils were also bonded to the baseplate while placing a thin (e.g., ˜25 μm) aluminum (Al 1100) interlayer foil or pure vanadium interlayer foil (e.g., an interlayer 116 shown in FIG. 1) between the titanium and the material beneath. In some implementations, the metallic interlayer defines a thickness of 30 μm or less. An alternate method of UAM bonding improvement was performed by sputtering (e.g., ˜200 nm) vanadium onto the surface of a CP Ti foil prior to bonding. Sputtering was performed by placing a CP Ti foil in an AJA ATC 2000 sputtering system. The system was at a base pressure of ˜3×10-7 Torr with a sputtering pressure of 5 mTorr Ar. The sample was rotated and sputtered for one hour and vanadium was sputtered onto the sample at 200 watts. In some implementations, a sputtered layer of vanadium defines a thickness of 300 nm or less. The thickness of the vanadium interlayer is based on the estimated elemental diffusion width created by the UAM deformation induced vacancy formation in titanium. This maximizes the amount of vanadium that can intermix into the titanium and facilitate the formation of the solid-state phase transformation into β titanium to help bonding, while not having a vanadium thickness that was too high that could eventually cause a detrimental loss in mechanical strength.

UAM bonding was performed on the titanium foils, and when the titanium had an interlayer or surface treatment, the sample was oriented so that surface mated with the material beneath. A schematic of this welding orientation is shown in FIG. 1. UAM bonding of the titanium 104, with and without interlayers 116, used a normal force of 8500 N, amplitude of 34.7 μm, and a speed of 50 inch/min using a Stellite-coated sonotrode horn 112. UAM bonding of titanium 104 with a sputtered vanadium surface 116 used a normal force of 9000 N, amplitude of 39.9 μm, and a speed of 50 inch/min with a Stellite-coated sonotrode horn 112.

Samples were cold mounted and mechanically polished down to a 0.05 μm surface finish using standard metallography procedures. Electron microscopy for imaging and energy dispersive spectroscopy (EDS) used a field emission Zeiss Gemini 450 with an acceleration voltage of 15 kV and a current of 20 nA. The EDS analysis used the semi-quantitative ZAF correction technique. Electron backscatter diffraction (EBSD) was performed on a field emission Zeiss Crossbeam 550 using an acceleration voltage of 25 kV and a current of 10 nA. Extreme care was observed to collect EDS and EBSD information on the same viewing region of a given sample. Lab x-ray diffraction was performed using a Panalytical Empyrean diffractometer with a copper x-ray source. Rietveld Refinement was performed using GSAS-II software. Preparation for transmission electron microscopy (TEM) was performed using a focused ion beam FEI Quanta 3D 200i with a gallium ion source. The sample was thinned progressively down to 5 kV with 48 pA. Transmission electron microscopy was performed on a 200 kV field emission Zeiss Libra MC, and convergent beam electron diffraction was performed using a 5 μm condenser aperture with a 240 mm camera length.

The commercially pure (CP) titanium foil was analyzed prior to ultrasonic additive manufacturing (UAM) to provide a baseline of comparison. CP Ti is often sold in different grades ranging from 1 to 4, depending on the levels of impurities including oxygen and iron. For example, grade 4 CP Ti can have an oxygen concentration of 0.4 wt. %, iron concentration of 0.5 wt. %, and exhibit yield strength, σ_{y} (stress at 0.2% plastic strain) of 480 MPa. In contrast, grade 1 CP Ti can have low impurity concentration (<0.18 wt. % O and <0.20 wt. % Fe) leading to soft foils with σ_{y} of 170 MPa. The CP Ti used here is grade 2 (<0.25 wt. % O, <0.30 wt. % Fe, σ_{y} of 275 MPa). Using grade 2 CP Ti, the phase transformation temperatures can be calculated using Thermo-calc® software 32.

As shown in FIG. 2, simulated phase fractions of CP Ti and Ti-6Al-4V are charted versus temperature. The calculations show that the CP Ti transforms from hexagonal closed packed (HCP) crystal (also referred as α-phase) structure to body centered cubic (BCC) crystal structure (also referred as β-phase) at ˜944° C. and to liquid above 1694° C. Therefore, at room temperature, we expect 100% HCP in CP Ti alloys with a small amount of BCC. However, the BCC phase will only be stable if the iron is allowed to partition during normal β to a transformation conditions.

As shown in FIGS. 3A-3D, experimental analysis was performed on the grade 2 CP Ti. FIG. 3A is the scanning electron microscopy (SEM) image of the foil, FIG. 3B is the band contrast, and FIG. 3C is the inverse pole figure (IPF) of the α phase. Electron backscatter diffraction (EBSD) analysis demonstrates a uniform and random orientation of grains. Clearly the α phase is the only phase present, which the thermodynamic equilibrium calculations also predict. Additionally, on the top of the foil, a small twin feature in the 0001 orientation is present along the original rolling direction of the foil. The chemical composition of the foil was examined using energy dispersive spectroscopy (EDS) (FIG. 3D). The titanium x-rays are the only distinguishable peaks. This also confirms that within the limits of detection, the CP Ti used in this study is pure and free from other elements. The common casting impurity elements present in grade 2 CP Ti, such as iron, could still exist in the material, although they would be below the detectable limit in SEM-EDS techniques.

The Ti-6Al-4V foil was also characterized prior to bonding for comparison. Thermocalc® calculations (see FIG. 2) demonstrate that in the Ti-6Al-4V material the α phase is dominant, although a small percent of β phase could also be present. The TB point is slightly higher than in the CP Ti material (see FIG. 2).

Experimental characterization of the as-received Ti-6Al-4V foil (see FIG. 4) indicates similar results to those above. The SEM image (see FIG. 4A) demonstrates that the foil is uniform. The EBSD analysis shows uniform band contrast throughout the foil (see FIG. 4B). The IPF of the α phase and the β phase are shown in FIGS. 4C and 4d, respectively. These calculations suggest 99% of the foil has the α phase. EDS characterization of the foil, shown with the EDS spectrum (see FIG. 4E), calculates that the foil is 92 wt. % Ti, 4 wt. % Al, and 3 wt. % V. The EDS and EBSD characterization demonstrate that the Ti-6Al-4V foil has an expected structure and composition within accepted experimental error.

As shown in FIG. 5, a thin (e.g., ˜25 μm) vanadium foil was used for one of the scenarios of improving bonding of Ti-6Al-4V. Prior to bonding, the vanadium interlayer was examined to confirm its composition and structure. An overview BSE image (see FIG. 5A) shows a uniform foil structure. Wavey lines are present in the image, likely a result of the foil rolling process. EDS maps of vanadium, chromium, and cobalt (see FIGS. 5b-d) and the EDS spectrum (see FIG. 5E) are shown which demonstrate the foil is entirely vanadium with no impurities above the detectable SEM-EDS limit. The EBSD band contrast and BCC-IPF pattern (see FIGS. 5f and 5g) further demonstrate a uniform and homogenous structure in the vanadium foil.

Once the CP Ti foil was successfully bonded using UAM, the material was characterized (see FIG. 6) in an orientation normal to the rolling direction of the sonotrode, as indicated. The SEM-BSE (backscatter electron) image of the bonded foil (see FIG. 6A) demonstrates significant features are present on the top surface of the foil, that were in contact with the sonotrode. Additionally, a crack is present on the right side of these features. The crack and other features appear to start at the top of the foil and progress downwards into the sample. A line is drawn on the image to indicate the direction of the EDS line scan. The quantified EDS maps of titanium, aluminum, and vanadium (see FIGS. 6b-d) demonstrate mostly uniform concentrations of these elements throughout the sample. Quantified EDS maps of impurity elements chromium and cobalt (see FIGS. 6e and 6f) show high concentrations of these elements are present near the top of the foil. Since these elements were not present in the foil prior to bonding, they were likely introduced during the UAM process. The UAM sonotrode horn had Stellite coating (Co—Cr alloy), therefore it is suspected these impurity elements came from the Stellite coating. Care was taken to characterize the sample using EBSD within the same field of view as the EDS analysis.

Throughout the sample, the EBSD band contrast (see FIG. 6G) demonstrate significant decrease in quality as compared to before bonding (see FIG. 3B). Near the crack and outside the crack there is an increase in pattern quality showing small almost equiaxed grains. The IPF of the α phase (see FIG. 6H) and the β phase (see FIG. 6I) show that most of the sample retained the α phase, although the β titanium phase is also present near the top of the foil. The existence of the α phase titanium in the UAM bonded CP Ti foil represents a significant deviation from the equilibrium of titanium. The β phase titanium is present at the same location as the higher concentration of impurity cobalt and chromium elements. The grains in the β phase appear small and roughly circular (or spherical in three dimensions). The α phase directly surrounding the β phase has small grains with several twin features oriented roughly perpendicular to the direction of the protruding β phase. At the bottom of the IPF image, the α phase has large grains and appears mostly undisturbed. The contrast changes from the BSE image, the shape of the cobalt and chromium introduction, and the direction of the β phase into the sample appear as sharp protrusions beginning at the top of the foil and extending downward into the sample in finger-like features.

The EDS data is shown in FIG. 7. The spectrum from the entire region (see FIG. 7A) has the x-ray peaks of titanium, chromium, and cobalt identified. A silicon Kα peak is also present in the spectrum, but this is likely an artifact from the polishing process, therefore it is not labeled or quantified. The EDS line scan (as indicated in FIG. 6A) is shown in FIG. 7B with the titanium, chromium, and cobalt concentrations. These impurity elements appear within twenty microns from the top of the foil and up to ˜20 wt. %.

Due to the unusual nature of the observed β phase in CP Ti, x-ray diffraction (XRD) was also performed (see FIG. 8). The sample was oriented such that the x-rays probed the top surface of the sample, as indicated by the diagram. From this orientation, approximately 50% of the data collected is from within 1.2 μm of the top surface, and 90% of the data collected is from within 4 μm of the top surface 33. The calculated phase fractions following Rietveld Refinement (see Table 1 below) show significant concentrations of the titanium α phase and the β phase on the top surface of the bonded foil. Additionally, the intermetallic Ti2Co and oxide CoO phases are present, although their concentrations are relatively small, which is why they are difficult to detect using EBSD analysis. Confirming the presence of β phase using EBSD and XRD methods significantly increase our confidence that this phase is present. The results shown in Table 1 indicate that successful bonding of titanium associated with an α→β titanium phase transformation.

TABLE 1
Calculated phase fractions from x-ray diffraction on the bonded foil

| Phases | Weight Percent |
|---|---|
| α-Ti | 58.3% |
| β-Ti | 38.2% |
| Ti2Co | 2.0% |
| CoO | 1.5% |

After the Ti-6Al-4V foil was UAM bonded to the baseplate, it was characterized using EDS and EBSD (see FIG. 9). All the sample images are oriented normal to the rolling direction of the sonotrode (like the bonded CP Ti sample shown in FIG. 6), therefore image orientation diagrams are not repeated for these samples. Several distinct features are present on the top of the bonded Ti-6Al-4V foil. From the BSE overview image (see FIG. 9A), swirl features are present on the top of the foil. A red line is drawn on the image to indicate the direction of the EDS line scan shown later. Quantified EDS maps of the titanium, aluminum, vanadium, cobalt, and chromium (see FIGS. 9b-9f) demonstrate mostly uniform concentrations of titanium, aluminum, and vanadium, while cobalt and chromium have been introduced on the top surface of the foil in swirl-like features. EBSD characterization was also performed in the same viewing region. There is increased band contrast at the top of the image as compared to deeper in the sample (see FIG. 9G). The IPF of the α phase (see FIG. 9H) and the β phase (see FIG. 9I) demonstrates that the α phase is present throughout most of the foil, while the top of the sample has the β phase.

The EDS data from the sample is shown in FIG. 10. The EDS spectrum from the entire area (see FIG. 10A) shows the identified x-ray peaks, and the EDS line scan (see FIG. 10B) demonstrates the concentrations of titanium, cobalt, and chromium as a function of distance from the sample surface. The cobalt and chromium impurity elements are within 30 microns of the top surface of the material and have large concentrations, with cobalt beyond 50 wt. % within the first several microns.

The bonded CP Ti and the bonded Ti-6Al-4V have several comparable features. In both samples, there is significant introduction of cobalt and chromium onto the top of the foil and β titanium formation. In the CP Ti sample, the UAM bonding results in finger-like features created on the top of the sample, while the Ti-6Al-4V sample has swirl-like features created on the top of the sample. The Ti-6Al-4V sample also has more penetration of the cobalt and chromium elements than the CP Ti sample.

UAM bonding of titanium is very difficult, and often results in the foil bonding to the sonotrode instead of the baseplate, which tears the material. To improve the UAM bonding ability of titanium, we hypothesize that the local crystal structure could be altered due to deformation during UAM bonding.

The first hypothesis is that if elements could more easily diffuse, then perhaps the bonding could be improved. To improve the interdiffusion of elements (which occurs primarily with atomic exchanges with vacancies through the Kirkendall effect), the material could be altered to allow a higher concentration of vacancies which could allow more atomic exchange pathways. This can be done by increasing the material's ability to form vacancies by decreasing the vacancy formation energy of the material. The introduction of aluminum can provide this effect because it has a low vacancy formation energy (E^{f}ᵥ of Al: 0.67 eV vs. E^{f}ᵥ of α Ti: 1.97 eV). As discussed in the following section, aluminum also increases the β transus point of titanium. This allows for the analysis of UAM HCP bonding by increasing the interdiffusion of elements without an α→β phase transformation.

To test this hypothesis, a Ti-6Al-4V foil was bonded to the baseplate using a thin aluminum interlayer between the foil and the baseplate. During UAM, some of the foil bonded, but most of the material cracked and broke off. Characterization was performed on a region of the material that remained mostly connected to the baseplate (see FIG. 11). SEM analysis (see FIG. 11A) shows that the titanium and aluminum interlayer appear intermixed with each other. There are several distinct regions of lower contrast elemental mixed materials surrounding higher contrast titanium. These regions are near the large crack in the sample, on the top surface of the sample, and on pathways connecting them. The quantified EDS maps (see FIGS. 11b-11f) of titanium, aluminum, vanadium, cobalt, and chromium demonstrate that the aluminum is mixed throughout the sample at the locations of dark SEM image contrast. This indicates that the aluminum interlayer mixes with the titanium. There is likely a weakly bonded joint which results in fracture of the material. The vanadium, cobalt, and chromium EDS maps indicate there are not significant concentrations of these elements in the sample.

EBSD analysis in this same region also demonstrates mixing of the materials during UAM bonding. The band contrast (see FIG. 11G) is poor throughout most the sample, suggesting small and/or heavily deformed grains are present. A small region at the bottom right of the image near the crack has slightly higher band contrast, suggesting larger grains there. The IPF of the α phase (see FIG. 11G), the β phase (see FIG. 11I), and the aluminum FCC phase (see FIG. 11J) suggest that most of the material retains the α phase. Near the regions with a high aluminum concentration and larger grains, the aluminum FCC phase and the β phase are detected. The low band contrast throughout the sample reduces our confidence in phase identification. The similarity in the FCC and BCC structures leads us to suspect that the β phase was not created in this sample.

The EDS data from this region can be further analyzed (see FIG. 12). The EDS spectrum from the entire viewing window is shown in FIG. 12A, and the various elements and sum peaks are identified. An EDS line scan, along the path indicated in FIG. 11A, is shown in FIG. 12B. The elements of titanium, aluminum, and cobalt are shown. Intimate intermixing of titanium and aluminum has occurred as the concentrations have exceeded a 50%-50% mixing point. Additionally, a small amount (˜5 wt. %) of cobalt is present.

As mentioned previously, it is hypothesized that the UAM bonding ability of titanium could be improved by altering the local crystal structure of the material. If the β phase could have increased stability, then perhaps the bonding ability could be improved. As demonstrated above, α→β phase transformation could occur during successful bonding of titanium as impurity elements of cobalt and chromium are introduced. Although cobalt and chromium are β stabilizing elements, they are considered β eutectic stabilizing elements. This means that when a small percentage of cobalt and chromium (up to 12.5 wt. % and 8.4 wt. % respectively) are introduced, they can reduce the β transus point. When larger concentrations of these elements are introduced, the β transus point increases, which makes it more difficult to form the β phase. Vanadium was chosen to introduce to titanium because it can reduce the β transus point with all concentrations. If the formation of the β phase is beneficial for bonding, then the introduction of vanadium should improve the UAM bonding ability. Furthermore, once there is a α→β phase transformation, the material has a lower vacancy formation energy (α Ti: 1.97 eV vs β Ti: 1.1 eV) therefore higher concentrations of vacancies and enhanced interdiffusion can occur. To test this hypothesis, vanadium was applied to titanium prior to UAM bonding. In this first scenario, a thin interlayer foil of vanadium was laid underneath a Ti-6Al-4V foil prior to bonding. In the second scenario discussed later, vanadium was sputtered onto the surface of CP Ti foil prior to bonding.

UAM bonding of titanium using a vanadium interlayer was successful. Due to this success, continued bonding of a titanium foil with a vanadium interlayer was performed. The final built structure that was examined has three layers of the titanium and vanadium combination. Imaging of this material (see FIG. 13) reveals several distinct features. An overview of the entire build (see FIG. 13A) demonstrates the multiple Ti-6Al-4V foils and vanadium interlayers. Like the bonded Ti-6Al-4V foil without an interlayer (see FIG. 9) swirls are present on top of the Ti-6Al-4V foil and on the top of the last foil added (top of the image). This suggests that the swirls are the result of the contact with the sonotrode. A magnification of the boundary of Ti-6Al-4V foils and a vanadium interlayer (see FIG. 13B) shows that the titanium and vanadium experience significant plastic deformation. In the undeformed region of the titanium, a typical basketweave microstructure is present. Closer to the vanadium, the Ti-6Al-4V has a quite different structure. The titanium has a higher contrast and has larger equiaxed grains. Additionally, the vanadium is significantly deformed. It appears that the titanium plastically flowed upward through the vanadium interlayer, pushing it up above the original interlayer boundary. Vanadium exists above and below the titanium. Additionally, there are large cracks on the right side of the image, and distinct dark contrast globular features surrounding the cracks. In addition to the large cracks, small (e.g., ˜200 nm) circular voids are present throughout the high contrast region of titanium. The nature of these voids is discussed further in the proceeding section.

The region shown in FIG. 13B was further characterized using EDS and EBSD all within the same field of view (see FIG. 14). FIG. 14A is an SEM image of the region of interest, repeated for comparison. A red line is drawn on the image indicating the direction of the EDS line scan. Quantified EDS maps of titanium, aluminum, vanadium, cobalt, and chromium are shown in FIGS. 14b-14f. The highest concentration of titanium and aluminum is in the Ti-6Al-4V foils, and the vanadium is predominantly in the interlayer foil. The cobalt and chromium are mostly within the Ti-6Al-4V foil near the interlayer, although they are also inside the vanadium interlayer.

The EBSD band contrast (see FIG. 14G) indicates there is reduced image quality in Ti-6Al-4V foils, and higher image quality near the foil interface and in the vanadium interlayer. The IPF of the titanium α phase (see FIG. 14H) shows that the HCP phase is present throughout the undeformed region of the Ti-6Al-4V foil. The IPF of the titanium β phase (see FIG. 14I) shows large equiaxed BCC grains. The BCC phase is detected in the vanadium and in the titanium. This indicates that the EBSD IPF map is convoluted by including the BCC vanadium and the BCC titanium. The higher pattern quality in the titanium near the interlayer is likely a result of the titanium transforming into the β phase. The α titanium likely has more stored dislocations and is more deformed, while the β phase has fewer dislocations and is less distorted.

Between the β titanium and the vanadium there is a region approximately 2 μm thick which has reduced image quality. This suggests finer grains could be present between the materials.

Quantification of the EDS data is shown in FIG. 15. The EDS spectrum (see FIG. 15A) shows the various identified x-ray peaks. The EDS line scan (see FIG. 15B) follows the path indicated in FIG. 14A. The line scan shows the elemental concentrations of titanium, vanadium, and cobalt. This demonstrates the titanium and vanadium are intermixed from the plastic deformation, and there are smooth diffusion profiles between the two materials. The cobalt impurity element is more dominantly present in the titanium rich regions, but cobalt is also distinctly present in the vanadium rich regions. Prior to UAM bonding, the vanadium interlayer did not contain impurity elements (see FIG. 5), and the vanadium was never in contact with the sonotrode.

The second scenario of using vanadium to improve bonding of titanium is now demonstrated. In this case, a thin surface treatment of vanadium was applied via sputtering to a CP Ti foil. After successful UAM bonding, the structure and interface were characterized (see FIG. 16). Using BSE imaging and SE-EDS techniques (see FIGS. 16a-16f), the interface can be clearly observed. The BSE contrast of the titanium changes at the interface and several small voids are present. A higher concentration of vanadium is present at the interface although there is not a significant delineation between the vanadium and the titanium, suggesting thorough intermixing between elements. No significant concentrations of aluminum, cobalt, or chromium are observed. The titanium interface was then further characterized using transmission electron microscopy (TEM) bright field (BF) imaging along with convergent beam electron diffraction (CBED). This was performed to understand the crystallographic structure of the material since the features are comparable with the spatial resolution of EBSD, limiting its use here. TEM-BF imaging was performed on the entire thinned sample and CBED was performed at specific locations as indicated (see FIG. 16G). Within the first few microns on the top of the TEM-BF image, a bright line is present. This is the interface that was targeted during focused ion beam (FIB) preparation. Small whisker type grains are present throughout the titanium surrounding the interface. CBED was performed at regions in the titanium that were suspected to contain the α structure and the transformed β structure. The CBED diffraction pattern far away from the interface is the HCP [2111] zone axis, and the CBED diffraction pattern at the interface is the BCC zone axis. FIG. 16 demonstrates that at the interface, the sputtered vanadium intermixes with the titanium resulting in an α→β phase transformation.

UAM is considered a solid-state low time and temperature bonding process. The time t of the thermal profile experienced during bonding is approximately 0.5 seconds. To rationalize the atomic motion observed here, a diffusion profile between materials can be considered (see FIG. 15 of the vanadium interlayer between Ti-6Al-4V foils). The diffusion distance x of 3.5 μm can be used to calculate an approximate diffusivity D value using Fick's 2nd law x˜Dt between the titanium and the vanadium. This is shown in Table 2 below. UAM studies of other HCP materials have estimated a thermal profile reaching as high as 400° C. The diffusivity of a Ti and β Ti can be compared for this temperature and even higher temperatures such as the β eutectic transus point with cobalt (650° C.) or the beta transus point for vanadium (944° C.). Table 2 demonstrates that the estimated experimental diffusivity of this study is far above that expected for a or B titanium at mild or even extreme temperatures. As shown in Table 2, even for these very high temperatures, the thermal equilibrium diffusivity is insufficient to explain the atomic motion; therefore other processes are most likely present.

TABLE 2
Diffusivity of Titanium

| Temperature | Diffusivity, α Ti | Diffusivity, β Ti | Experimental Diffusivity |
|---|---|---|---|
| (° C.) | (m²/s) | (m^{s}/s) | (m²/s) |
| 400 | 3.3 × 10⁻²³ | 2.2 × 10⁻¹⁶ | |
| 650 | 6.9 × 10⁻¹⁸ | 2.6 × 10⁻¹⁵ | |
| 944 | 2.0 × 10⁻¹⁴ | 4.9 × 10⁻¹⁴ | |
| | | | 4.9 × 10⁻¹¹ |

A very large point defect vacancy concentrations can be created during the plastic deformation UAM bonding. These vacancies can enhance atomic diffusion by increasing the number of lattice sites available for atomic migration. The expression for Brownian atomic motion, D=α₀² Xᵥ v·exp (−Eₘ/kT), can be used to rationalize the concentration of vacancies present. Here a₀ is the lattice constant, Xᵥ is the vacancy concentration, v is the Debye frequency of the atomic vibrations on its lattice site, Eₘ is the vacancy migration energy, k is the Boltzmann constant (8.617×10-5 eV/K), and T is the absolute temperature. The vacancy concentration in titanium would be approximately 3×10⁻⁵−2×10⁻⁴ depending for the temperature reached during bonding.

The cobalt and chromium elements in the titanium are likely introduced when a diffusion couple is created between the Stellite sonotrode and the titanium. Accelerated interdiffusion then occurs due to a high concentration of point defect vacancies. Enhanced concentrations of vacancies are also created at the interfaces resulting in the interlayers and elemental surface modifications diffusing during bonding.

There is also evidence of the cobalt element entering into the vanadium interlayer (see FIGS. 14 and 15). As noted previously, the cobalt is not present in the vanadium interlayer prior to UAM (see FIG. 5) and the sonotrode never touches the vanadium interlayer (see FIG. 1). Therefore, the cobalt must have diffused from the sonotrode into the titanium, and then when the subsequent layer is added on top, the cobalt back diffuses into the vanadium.

The introduction of β phase can be rationalized on the role of the introduction of elements such as Co, Cr, V, and Al to the titanium, as well as the plastic strain induced on the material. In pure titanium alloys, as per thermodynamic calculations, the onset of the allotropic α to β transus temperature (Tβ) is calculated to be 881.4° C. As suggested from the results above, the β transus temperature can also decrease with the addition of certain elements. The rate of the β transus temperature reduction as a function of solute fraction (˜2%) can be calculated using the Thermocalc® program 32 using the TCTI2 module: d(T_{β})/d(wt. fraction Co)=−2098: d(T_{β})/d(wt. fraction Cr)=−1959; d(T_{β})/d(wt. fraction V)=−1595: d(T_{β})/d(wt. fraction Al)=2299. Clearly cobalt, chromium, and vanadium decrease T_{β} as they are added to titanium (hence the negative d(TB)/d(wt. fraction solute) values). Therefore, as these elements diffuse into titanium, they make it easier for the β phase to form, which we experimentally observe. Conversely aluminum increases T^{β} as it is added to titanium. This makes it more difficult for the β phase to form, therefore it is not surprising that we do not observe the β phase to form with the aluminum interlayer.

In addition to the introduction of elements, the stability of the α phase can be considered from a thermodynamic perspective. At temperatures below T_{β}, the α phase is more thermodynamically stable than the β phase. Therefore, the α phase has a lower Gibbs free energy and the material cannot overcome the energetic barrier to form the β phase. If the α phase has significant plastic deformation, the phase will become more deformed and work hardened, and the Gibbs free energy of that phase will increase with respect to the β phase. As temperature or the amount of deformation increases, the energy barrier to form the β phase decreases. This can happen until the β phase is more thermodynamically stable than the α phase, allowing the nucleation of the β phase at lower temperatures (reduction of the T_{β} point). This strain induced phase transformation has been observed in several studies of plastic deformation on titanium alloys. Cyclic thermo-mechanical plastic deformation can result in strain accumulation increasing the amount of β phase. Since the UAM process creates plastic deformation through a biaxial stress state (i.e., the normal force and transverse force from the sonotrode oscillating at 20 kHz), it is reasonable to conclude that the fraction of the transformed titanium β phase could be higher than that seen through uniaxial tension or compression tests.

During thermal reversals, the β titanium phase nucleates inside of grains at lattice defects and along grain boundaries. As the β grains grow, they sweep across the transformed and untransformed material consuming smaller grains. Phase transformations during hot deformation occur at stress concentration locations, grain boundary triple points, and at lattice defects such as dislocations. As deformation occurs at higher strain rates, more lattice defects or sub-grain boundaries could be formed. The higher concentration of defects can then facilitate further nucleation and growth of the β phase.

A higher fraction of titanium could have a strain induced β phase transformation with higher applied strains and strain rates. A longer holding time at an elevated temperature results in more β phase reverting back into the α phase. The amount of retained β phase depends on the cooling rate of the titanium. When the material is rapidly cooled (above 15° C./s) β phase can remain, while slower cooling allows the β phase to revert back to the α phase. The high strain rate UAM deformation could reduce the T_{β} point, inducing more β phase to form while the short bonding time, along with the heavily deformed structure, would mitigate the reverse transformation back to α phase. Since the UAM process has a total bonding time of 0.5 seconds, the α phase does not have time to transform back, and β phase remains.

In addition to the diffusion of elements and phase transformations, there are other features present in the materials such as voids and material cracking at the titanium-vanadium joint (see FIG. 13B). As determined from the image, the voids are roughly 200 nm in diameter. The voids that are commonly observed at UAM interfaces are lack of contact voids between mating foil surfaces. These voids are created because of imperfect contact between the asperities of the rough surfaces. These voids are typically tens of microns in diameter and are described as jagged parabola-like defects. Since the voids observed here are smaller, circular, several microns away from the interface, and fully encapsuled by titanium, they are likely not non-contact voids. Nanometer sized voids have been previously observed along UAM interfaces due to vacancy clusters from the agglomeration of individual point defect vacancies introduced during the UAM deformation process. Voids from vacancy clusters are typically 1-10 nm in diameter, therefore the voids observed here appear distinct from vacancy clusters because they are much larger. Additionally observations of materials subject to severe plastic deformation typically do not observe these type of voids or porosity. The phase transformation of α→β titanium is also not expected to create voids since the transformation is diffusionless and the two phases have similar molar volumes.

Although the individual microstructure changes are insufficient to explain the microvoids, the material in the present study had a complex combination of phase transformations and plastic deformation. Therefore, plastic deformation of dual phase titanium alloys could provide some insight regarding these voids. As titanium plastically deforms during hot working, a complex microstructure evolution occurs. This includes phase transformations, dislocation multiplication and pile-up, dynamic recovery, and dynamic recrystallization. Since the HCP α phase is a harder material than the BCC β phase, these microstructure changes can manifest as mechanical strengthening, softening, and strain mismatch. When dual phase titanium alloys have significant plastic deformation, the mechanical heterogeneity between the α phase and the β phase can result in stress concentrations.

High resolution TEM analysis in an α/β titanium alloy has demonstrated that initial plastic deformation can begin uniformly in the α phase, then as uniform deformation is difficult to proceed, microvoids appear at α/β interfaces and further deformation results in void growth. After plastic deformation, significant dislocation entanglements and shear bands were found at an α/β interface that was incoherent. This demonstrates that the a/β interface experiences much higher stress than at grain interiors. Microvoids were found throughout their material with 83% of the voids at α/β interfaces. These voids were the result of deformed grains making sharp interfaces and stress concentrations during deformation. Voids were also found inside of β grains, although these voids were the result of non-uniform grains creating uneven strains. In the present study, the β grains are mostly uniform in shape, suggesting an uneven strain would not be created there. This indicates that the microvoids are created at α/β interfaces, then a titanium continues to transform into β titanium which results in the voids being surrounded in β titanium. Continued plastic deformation can result in microvoid growth and coalescence, although small, recrystallized grain boundaries can hinder their growth. When the microvoids are not hindered by recrystallized grain boundaries, they can grow to a critical size and further UAM plastic deformation can shear the material. This results in the material developing large tears, as seen on the right side of FIG. 13B.

UAM bonding is achieved primarily due to the plastic deformation of the crystal structure. During bonding of titanium, the aluminum interlayer accelerates interdiffusion through enhanced concentrations of point defect vacancies, although the titanium remains in the α phase resulting the material cracking. For bonding with vanadium, the β titanium phase is promoted. This increases the ability of UAM to plastically slip and deform because of the higher number of β phase slip systems. Once the titanium transforms to the β phase there is a lower vacancy formation energy which could enhance the vacancy concentration and promote more interdiffusion of elements.

Future improvements to UAM bonding can be obtained by performing surface treatments or adding small interlayers at the faying interfaces. Vanadium and aluminum interlayers are specifically relevant for understanding the fundamental mechanisms associated with UAM bonding of titanium based on the thermodynamic calculations of their solute interactions with titanium (in particular, their influence on lowering the beta transus temperature in titanium). Materials of high interest for future surface treatments include those that increase the stability of the material to plastically deform. Additionally, it is demonstrated that UAM can alter the crystal structure of materials during bonding. The high strain rate plastic deformation causes enhanced interdiffusion and phase transformation of materials. This is a significant discovery that could be used for future material design and modification.

Successful UAM bonding of titanium in the hexagonal close packed, a phase, using commercially pure titanium and the Ti-6Al-4V alloy can be achieved as described herein. As the titanium bonds, interdiffusion of elements occurs. The elements that are introduced which reduces T_{β} result in the titanium forming the β phase, while elements that do not lower the T_{β} point do not result in the titanium phase transformation and result in poor bonding (build fracture). In addition to the introduction of elements promoting an alpha to betα phase transformation, the phase transformation is rationalized due to a strain induced phase transformation in the material from the plastic deformation UAM process. These techniques are well suited for improving the UAM bonding ability of HCP materials.

As discussed above, successful welding of one layer of 0.006″ thick Ti64 foil on a Ti64 baseplate using 0.001″ thick vanadium foil (purity 99.8%) as an interlayer was accomplished. Further adjustment of welding parameters for the ultrasonic additive manufacturing (UAM) system has also been undertaken wherein six layers of 0.006″ thick Ti64 foil were welded on a Ti64 baseplate, using 0.001″ thick vanadium interlayers between Ti64 layers. The welding strength between the baseplate and 1^{st} layer of Ti64 foil was identified to be 369.37 MPa through shear testing. In order to evaluate the shear strength of the foil-base interface, shear tests and tensile tests on as-received bulk Ti64 were performed for a USS/UTS ratio to estimate the transverse shear strength of UAM-welded Ti64 foil. In order to improve the shear strength of the foil-base interface, heat treatment can be applied to the UAM-welded material, resulting in an increase to 769.30 MPa in Ti64 foil-interface shear strength. For reference, the USS of bulk Ti64 is 762.91 MPa.

Testing was conducted using Ti64 foils that are 0.625″ (15.88 mm) wide and 0.006″ (0.15 mm) thick. The same material, Ti64, is used for the baseplate (e.g., size 16″×16″×0.13″,406.4×406.4 mm×3.30 mm). In order to help improve bonding, 0.001″ thick vanadium foil is used as an interlayer material between Ti64 foils. As shown in FIG. 17, when welding each layer of Ti64 foil 200, a vanadium interlayer 204 is laid below it before running the welder sonotrode 112 over the top layer of the foil 200, welding both the vanadium interlayer 204 and the top layer of Ti64 foil 200 (referred to as one bilayer) at the same time.

In order to test the weld strength and investigate the parameters for welding multiple Ti64 foil layers, two samples were built, each with 8 bilayers (one 0.006″ thick Ti64 foil and one 0.001″ thick vanadium foil) welded on Ti64 baseplates. Shear specimens were then cut out from the two welding samples to test the welding strength between the first bilayer and the Ti64 baseplate.

Both welding samples were built under room temperature conditions (i.e., no preheating). Table 3 and Table 4 show a summary of welding parameters for the two samples, respectively.

TABLE 3
Summary of Ti64 foil on Ti64 baseplate for sample #1

| | | | Speed | |
|---|---|---|---|---|
| | Force | Amplitude | [in/min | |
| Bilayer | [N] | [μm] | (mm/s)] | Results |
| Texturing | 7500 | 32.17 | 150 (63.50) | Uniformly textured |
| 1^{st} | 8500 | 34.06 | 55 (23.28) | Bond between layer and baseplate |
| 2^{nd} | | | | Bonded, nuggets at start of weld |
| 3^{rd} | | | 52 (22.01) | Bonded, foil veered, no nugget |
| 4^{th} | | | | Bonded, nuggets at middle part |
| 5^{th} | | | 50 (21.17) | Bonded, nuggets at middle part |
| 6^{th} | | | | Loose bonding |
| 7^{th} | | | 48 (20.32) | Loose bonding |
| 8^{th} | | | 45 (19.05) | Loose bonding, foil can be peeled |
| | | | | off |

TABLE 4
Summary of Ti64 foil on Ti64 baseplate for sample #2

| | | | Speed | |
|---|---|---|---|---|
| | Force | Amplitude | [in/min | |
| Bilayer | [N] | [μm] | (mm/s)] | Results |
| Texturing | 7500 | 32.17 | 150 (63.50) | Uniformly textured |
| 1^{st} | 8500 | 34.06 | 55 (23.28) | Bond between layer and baseplate |
| 2^{nd} | | 34.06 | | Bonded, nuggets at edge of weld |
| 3^{rd} | | 34.70 | 52 (22.01) | Bonded, nugget at beginning part |
| 4^{th} | | 35.33 | | Bonded, no nugget |
| 5^{th} | | 35.96 | 50 (21.17) | Bonded, no nugget |
| 6^{th} | | 36.59 | | Bonded, no nugget |
| 7^{th} | | 37.23 | 48 (20.32) | Bonded only at beginning of weld |
| 8^{th} | | 37.86 | 45 (19.05) | area, foil veered during welding |

For both samples #1 and #2, the welding parameters for texturing and welding the 1^{st} bilayer are the same, as listed in the tables above. The weld result of the 1^{st} bilayer in both samples was consistent. To compensate for a more consistent weld strength, welding parameters need active adjustment as layers build up. In order to investigate proper welding parameters to build multiple bilayers, parameters were adjusted differently for two samples, starting from the 2^{nd} bilayer.

For sample #1, normal force (8500 N) and welding amplitude (34.06 μm) were kept the same as layers are added, while the welding speed is decreased from 55 inch/min (23.28 mm/s) at the 2^{nd} bilayer to 45 inch/min (19.05 mm/s) at the 8th bilayer. It was observed that nuggets occur at multiple spots when welding the 2^{nd}, 4^{th}, and 5^{th} bilayers, which suggests the bonding conditions were not ideal. The 3^{rd} bilayer veered during the welding process, which may have increased the difficulty to weld the next several bilayers of foil. The 6^{th}, 7^{th}, and 8^{th} bilayers did not achieve strong bonding, which is possibly the result of lack of welding power and poor surface condition (e.g., caused by nuggeting of previous layers).

For sample #2, normal force was kept the same (8500 N), while both the welding speed and welding amplitude were actively adjusted simultaneously as layers build up as shown in Table 4. Welding amplitude increased from 34.06 μm when welding the 1^{st} and 2^{nd} bilayers to 34.86 μm when welding the 8^{th} bilayer. Welding speed decreases from 55 inch/min (23.28 mm/s) at the 1^{st} bilayer to 50 inch/min (21.17 mm/s) at the 8^{th} bilayer.

It was observed that nuggets only occur at the edge of the welding area on the 2^{nd} bilayer and beginning part of the welding area on the 3^{rd} bilayer. The welding of the 4^{th}, 5^{th}, and 6^{th} bilayers of foil was observed to be consistent with 1^{st} bilayer, which indicates ideal bonding condition. The 7^{th} and 8^{th} bilayers veered during the welding process. Thus only the beginning part of the foil was bonded, suggesting that the parameters for welding the 7^{th} and 8^{th} bilayers need more adjustment.

Once the welding samples are built, shear specimens were cut out from UAM-welded material for testing using the 0.125″ diameter endmill, with dimensions as shown in FIG. 18. Shear specimens are first cut into cuboids with dimensions 0.197″×0.197″×0.256″ (5 mm×5 mm×6.5 mm), then the samples are machined to leave an 0.088″ (2.24 mm) step as illustrated in FIG. 18C.

Shear tests were conducted with a shear fixture, shown in FIGS. 18D and 18E, together with an MTS C43.504 load frame and compression platens. The speed of the crosshead is controlled to be 1.27 mm/min and displacement is measured with the built-in MTS encoder. Ten shear specimens were tested.

Table 5 shows the results of the shear tests, including the average ultimate shear strength (USS) and the standard deviation (results of shear specimens #2, #3 and #10 were ruled out due to unclear shearing surfaces observed).

TABLE 5
Shear test results for UAM-welded
Ti64 foil-to-base weld interfaces

USS (MPa)

| | Average | Std Dev |
|---|---|---|
| UAM-weld Ti64 | 369.37 | 37.08 |

In order to evaluate the shear strength of the UAM Ti64 material (material away from weld interfaces), transverse shear testing is required. Shear testing and tensile testing on the as-received bulk Ti64 baseplate were performed to calculate the USS/UTS relationship to estimate the transverse shear strength of the UAM-welded Ti64.

Dogbone samples use an ASTM E8 subsize sample geometry, with a thickness of 0.128″ (3.25 mm). Shear specimens are first cut into cuboids with dimensions 0.197″×0.130″×0.256″ (5 mm×3.30 mm×6.5 mm), then the samples are machined to leave an 0.088″ (2.24 mm) step as shown in FIG. 19. An MTS C43.504 load frame with wedge grips was used to carry out the tensile tests, with a crosshead speed of 1.27 mm/min. The strain of the dogbone samples was measured with a Correlated Solutions VIC-3D digital image correlation (DIC) system. Four dogbone samples were tested.

Shear tests were conducted on the shear specimens shown in FIG. 19 with the shear fixture, as shown in FIG. 18D, together with the MTS C43.504 load frame and compression platens. The speed of the crosshead is controlled to be 1.27 mm/min and displacement is measured with the built-in MTS encoder. Twelve shear specimens were tested.

Table 6 shows the results of the shear and tensile tests, including the average ultimate shear strength (USS), ultimate tensile strength (UTS), and their standard deviations.

TABLE 6
Shear test and tensile test results of as-received bulk Ti64

| | |
|---|---|
| USS (MPa) | UTS (MPa) |

| | Average | Std Dev | Average | Std Dev |
|---|---|---|---|---|
| Bulk Ti64 | 762.91 | 18.86 | 1125.61 | 6.54 |

The ultimate tensile strength and ultimate shear strength of the as-received bulk Ti64 samples were 1125.61 MPa and 762.91 MPa, respectively. Thus, the USS/UTS ratio is 0.68. The as-received Ti64 foil had an ultimate tensile strength of 775.30 MPa. Therefore, using the USS/UTS ratio obtained above, the transverse shear strength of UAM-welded Ti64 is estimated to be 527.20 MPa.

The average shear strength of the Ti64 foil-base interfaces tested is 369.37 MPa, which is 70.07% as strong as the estimated transverse shear strength (527.20 MPa). It may be possible to improve the welding strength of the Ti64 foil-base interface by further optimizing welding parameters.

Post weld heat treatment can be used to improve the welding strength of UAM-welded materials, such as stainless steel 410 and steel 4130. Another sample (sample #3) was built using the same parameters as shown in Table 4, with eight bilayers (one 0.006″ thick Ti64 foil and one 0.001″ thick vanadium foil for each bilayer) welded on the Ti64 baseplate.

Solution treatment was applied to the shear specimens after they were cut out from sample #3. The shear specimens were heated to 1065° C. for 1 hour in a sealed bag, followed by water quenching, then the quenched samples were aged for five hours at a temperature of 605° C.

Shear tests were conducted with the shear fixture, as shown in FIG. 17, together with a MTS C43.504 load frame and compression platens. The speed of the crosshead was controlled to be 1.27 mm/min and displacement was measured with the built-in MTS encoder. Six shear specimens were tested.

Table 7 shows the results of the shear tests, including the average ultimate shear strength (USS) and the standard deviation (result of heat-treated shear specimen #2 is ruled out due to unclear shearing surfaces observed). The full shear stress-displacement curves for the heat-treated shear specimens #1-#6 are plotted in FIG. 19.

TABLE 7
Shear test results for post heat treated UAM-
welded Ti64 foil-to-base weld interfaces

USS (MPa)

| | Average | Std Dev |
|---|---|---|
| Post heat treated UAM- | 769.30 | 57.51 |
| welded Ti64 | | |

Post-UAM heat treatment was applied to the shear specimens. After the heat treatment, the average shear strength of the Ti64 foil-base interface reached 769.30 MPa, representing an increase of 399.92 MPa compared to the UAM as-welded (without the solution treatment) Ti64 shear specimens.

As discussed above, six bilayers (one 0.006″ thick Ti64 foil and one 0.001″ thick vanadium foil for each bilayer) were successfully welded on a Ti64 baseplate. Welding strength of the foil-base interface was tested to be 369.37 MPa using miniature shear specimens. In order to improve the shear strength of the foil-base interface, heat treatment was applied to the UAM-welded samples, resulting in an increase to 769.30 MPa in Ti64 foil-interface shear strength.

To address problems encountered during development of the technologies discussed herein, process parameter adjustments were carried out. With a normal force of 8,500 N, welding speed of 50 inch/min, amplitude of 34.7 μm, a first layer of CP Ti foil was successfully welded on a Ti64 baseplate at room temperature. 8,500 N and 34.7 μm may represent a minimal normal force and amplitude for CP Ti welding.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

What is claimed is:

1. A method of welding a first layer of Ti alloy to a second layer of Ti alloy, the method comprising:
disposing a metallic interlayer onto a first layer of Ti alloy;
disposing the second layer of Ti alloy onto the metallic interlayer such that the metallic interlayer is disposed between the first layer of Ti alloy and the second layer of Ti alloy; and
applying a horn of an ultrasonic device to the second layer of Ti alloy to weld the first layer of Ti alloy to the second layer of Ti alloy to form a welded material.

2. The method of claim 1, wherein the Ti alloy comprises Ti-6Al-4V and the metallic interlayer comprises vanadium.

3. The method of claim 1, wherein the first layer of Ti alloy and the second layer of Ti alloy have thicknesses of 0.01 inches or less.

4. The method of claim 3, wherein the first layer of Ti alloy and the second layer of Ti alloy have thicknesses of 0.002 inches or less.

5. The method of claim 1, further comprising heat treating the welded material.

6. The method of claim 5, wherein heat treating comprises heating the welded material to a solutionizing temperature to solutionize the welded material.

7. The method of claim 6, wherein the solutionizing temperature is at least 850° C.

8. The method of claim 7, wherein the solutionizing temperature is at least 950° C.

9. The method of claim 8, wherein the solutionizing temperature is at least 1050° C.

10. The method of claim 6, wherein heating the welded material to a solutionizing temperature is performed for at least 1 hour.

11. The method of claim 5, wherein heat treating further comprises water quenching the welded material.

12. The method of claim 11, wherein water quenching occurs after heating the welded material to a solutionizing temperature.

13. The method of claim 5, wherein heat treating further comprises heating the welded material to an aging temperature to stabilize α phase of the welded material.

14. The method of claim 13, wherein heating the welded material to an aging temperature occurs after water quenching the welded material.

15. The method of claim 13, wherein the aging temperature is between 550° C. and 700° C.

16. The method of claim 15, wherein the aging temperature is 605° C.

17. The method of claim 13, wherein heating the welded material to an aging temperature is performed for at least 2 hours.

18. The method of claim 17, wherein heating the welded material to an aging temperature is performed for 5 hours.

19. The method of claim 1, wherein the metallic interlayer includes a layer of vanadium,
wherein the layer of vanadium is a first layer of vanadium, further comprising, after disposing the second layer of Ti alloy and before applying the horn of the ultrasonic device:
disposing a second layer of vanadium onto the second layer of Ti alloy such that the second layer of Ti alloy is disposed between the first layer of vanadium and the second layer of vanadium; and
disposing a third layer of Ti alloy onto the second layer of vanadium such that the second layer of vanadium is disposed between the second layer of Ti alloy and the third layer of Ti alloy.

20. The method of claim 1, wherein the layer of vanadium comprises a vanadium foil defining a thickness of 30 μm or less, or a sputtered layer of vanadium defining a thickness of 300 nm or less.
